(19) United States
(12) Patent Application Publication
(10) Pub. No.: US 2003/0081427 A1
(43) Pub. Date: May 1, 2003

(54) Sealing bulb boot for moveable reflectors

(75) Inventors: Kevin L. Judd, Pendleton, IN (US); Paul H. Fort, Anderson, IN (US); Douglas A. Elrod, Pendleton, IN (US); Robert A. Kidd, Alexandria, IN (US); Jack D. Bodem, Kokomo, IN (US); Vince E. Stanley, Wilkinson, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, Pendleton, IN

(21) Appl. No.: 10/251,005

(22) Filed: Sep. 20, 2002

Related U.S. Application Data
(60) Provisional application No. 60/335,402, filed on Oct. 31, 2001.

(51) Int. Cl. B60Q 1/00

(52) U.S. Cl. 362/548; 362/549; 362/267; 362/310

(57) ABSTRACT

A sealing bulb boot for use in a vehicular lighting assembly comprising a boot with a lip running along its outer perimeter and a hole at its approximate center. The hole in the boot is generally circular in configuration with at least one notch which allows a conventional tabbed locking mechanism of a light source, which requires an approximate quarter turn to lock the light source to the reflector, to pass therethrough. The outer lip of the sealing bulb boot presses around a portion of the housing of the lighting assembly. A seal is also created around the inner portion of the sealing bulb boot upon the insertion of the light source through the hole at the center of the boot and the turning of the light source to engage the light source's locking mechanism.

### CROSS-REFERENCE TO RELATED APPLICATION

This application claims the benefit of U.S. Provisional Application No. 60/335,402, filed Oct. 31, 2001.

### BACKGROUND OF THE INVENTION

The present invention relates generally to vehicular lamps. More specifically, the present invention relates to means used as environmental seals between lamp sockets and moveable reflectors.

All automotive forward lighting assemblies, including headlamps and fog lamps, comprise a light source which provides illumination. The light from this source is directed away from the automobile to illuminate the surface of the road and the space in front of the vehicle by a reflector. Several types of reflectors for vehicular forward lighting assemblies are used in the industry. These include parabolically-shaped reflectors which are used in standard forward lighting assemblies and elliptically-shaped reflectors which are used in projector lamps. In addition to being available in varying shapes, reflectors can also be divided into those that are moveable and those that are fixed. Moveable reflectors allow for the adjustment of the beam of the light source without the need for movement of the entire lighting assembly. To protect the light source from moisture and other harmful environmental effects, the light source is usually enclosed by the reflector and a clear or translucent cover which allows emitted light to pass through but protects the lamp bulb from the elements. However, to fully protect the light source, many lamp assemblies also include an environmental seal around the rear of the reflector known as a sealing bulb boot.

There are several qualities that are desirable in a sealing bulb boot used with a moveable reflector. First, it is desirable and necessary for the scaling bulb boot to form a tight seal around the reflector. This tight seal is required to block moisture and other elements from entering the lamp and potentially causing premature failure of the light source. Second, it is desirable for the sealing bulb boot to seal tightly around the lamp bulb socket without the need for an additional gasket around the base of the socket. The necessity of a separate gasket around the lamp bulb socket would increase the overall cost of the headlamp and therefore should be avoided. Third, it would be desirable for a sealing bulb boot to seal to a moveable reflector that has a simple mold design, preferably one which does not require additional design features over a fixed reflector. Once again this reduces the cost of the fabrication of the piece. Fourth, a successful boot design should be relatively simple to install and require a minimum number of assembly steps to secure to the reflector and around the lamp bulb socket. Any assembly steps which can be eliminated while maintaining a boot that still forms a tight seal saves money in the manufacturing and assembly process.

Current sealing bulb boot designs commonly require that the associated moveable reflector have a groove molded into it for mating with the sealing bulb boot. In particular, the sealing bulb boot is then sealed in such assemblies by being seated into the groove. In the alternative, no groove is used but the sealing bulb boot must be very tight around the “neck” of the light bulb socket to effectuate a seal. The requirement of an extra molded groove increases the price of the reflector. The alternative of a tight fit also adds cost because it makes the sealing bulb boot much more difficult to install. Current boot designs have other shortcomings as well. For example, they commonly require an extra gasket around the lamp socket base to ensure a tight seal. Also, additional means of boot retention may be required to ensure the boot does not come loose and break the environmental seal potentially causing premature light source failure.

Thus, a need exists for a sealing bulb boot which can be manufactured inexpensively, which forms a tight seal around the reflector, and which allows for the simplest assembly possible without the need for additional gaskets or sealing means. Additionally, the sealing bulb boot design should not require additional design features to be molded into the moveable reflector.

### BRIEF SUMMARY OF THE INVENTION

The present invention comprises a sealing bulb boot for use with vehicular lighting assemblies, especially automotive forward lighting assemblies, utilizing a moveable reflector. In particular, the sealing bulb boot of the present invention comprises a boot, which may be molded of a flexible material, with a lip running along its outer perimeter and a hole at its approximate center. In an exemplary embodiment of the present invention, the hole in the approximate center of the boot is generally circular in configuration with at least one notch, and in particular for one exemplary embodiment three (3) notches, which allow a conventional tabbed locking mechanism of a light source to pass therethrough. Such tabbed locking mechanisms for automotive light sources, which require an approximate quarter turn of the light source after insertion in the reflector to effectively lock the light source to the reflector, are well known by those of ordinary skill in the art.

In use, the outer lip of the sealing bulb boot presses around a portion of the housing of the lighting assembly. Additionally, a seal is created around the inner portion of the sealing bulb boot upon the insertion of the light source through the hole at the center of the boot and the turning of the light source to engage the light source's quarter turn locking mechanism. Once the light source is locked into place, the sealing bulb boot creates an effective seal around the housing, the light source, and the reflector.

### BRIEF DESCRIPTION OF THE DRAWINGS

FIG. 1 is a rear perspective view of a vehicular lighting assembly without a sealing bulb boot of the present invention;

FIG. 2 is a rear perspective view of a light source and a movable reflector without a sealing bulb boot of the present invention;

FIG. 3 is a side cross-sectional view of the vehicular lighting assembly of FIG. 1 with an exemplary embodiment of a sealing bulb boot of the present invention;

FIG. 4 is a rear view of the exemplary embodiment of the sealing bulb boot of the present invention shown in FIG. 3; and

FIG. 5 is a rear view of the vehicular lighting assembly of FIG. 1 with the exemplary embodiment of the sealing bulb boot of the present invention shown in FIG. 3.

### DETAILED DESCRIPTION OF THE INVENTION

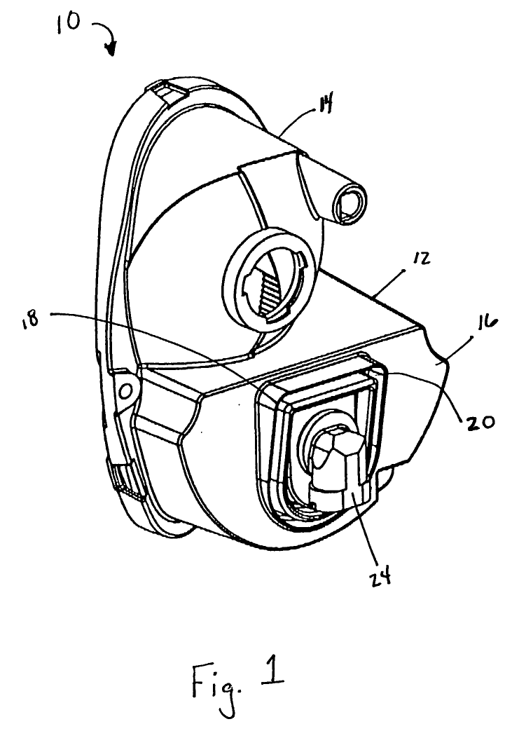

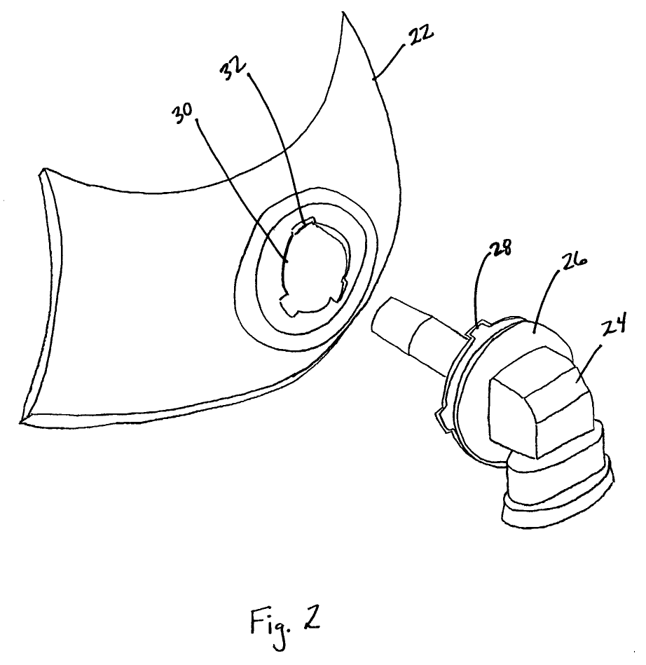

The present invention provides for a sealing bulb boot for use in a vehicular lighting assembly with a moveable reflector. FIG. 1 shows a rear perspective view of an exemplary automotive forward lighting assembly 10 which comprises housing 12 with signal/drl (i.e., signal/daytime running lamp) portion 14 and fog lamp portion 16. As shown in FIG. 1, fog lamp portion 16 comprises outer ridge 18 and groove 20. Referring now to FIG. 1 and FIG. 2, automotive forward lighting assembly 10 further comprises moveable reflector 22 and light source 24. Light source 24 comprises face plate 26 and locking tabs 28. Moveable reflector 22 comprises opening 30 which is generally circular in cross-section and includes notches 32 which are suitably sized to allow locking tabs 28 of light source 24 to pass therethrough.

In assembly, light source 24 is inserted into opening 30 of moveable reflector 22, in such a manner that locking tabs 28 pass through notches 32. Once inserted, light source 24 is rotated approximately one quarter turn to thereby lock light source 24 into proper position with slots provided in moveable reflector 22 and fixedly secure light source 24 to moveable reflector 22. It should be noted that such one quarter turn locking mechanisms are well known to those of ordinary skill in the art.

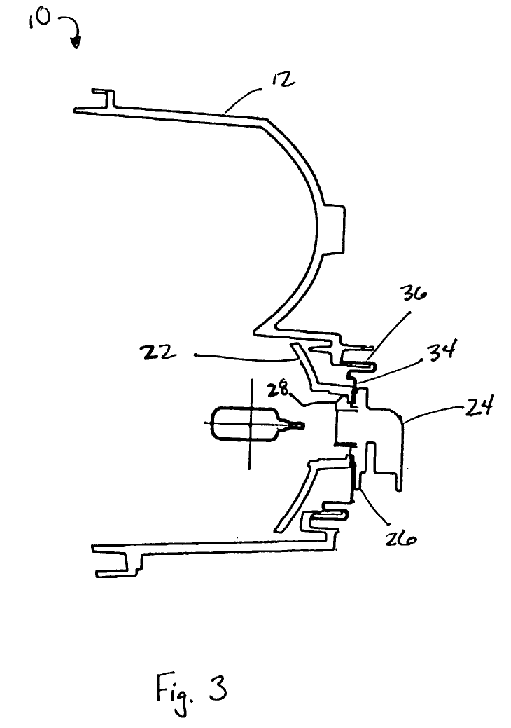

FIG. 3 shows a cross-section view of automotive forward lighting assembly 10, including an exemplary embodiment of sealing bulb boot 34 of the present invention. Sealing bulb boot 34 is molded from a flexible material with outer lip 36 running along its outer perimeter. In particular, sealing bulb boot 34 may be molded through an injection molding process from a black thermoplastic rubber compound, which is commercially available from the American Rubber company. Sealing bulb boot 34 may also be molded from a black solid rubber material per SAEJ200. Outer lip 36 fits around outer ridge 18 of housing 12 and presses into groove 20.

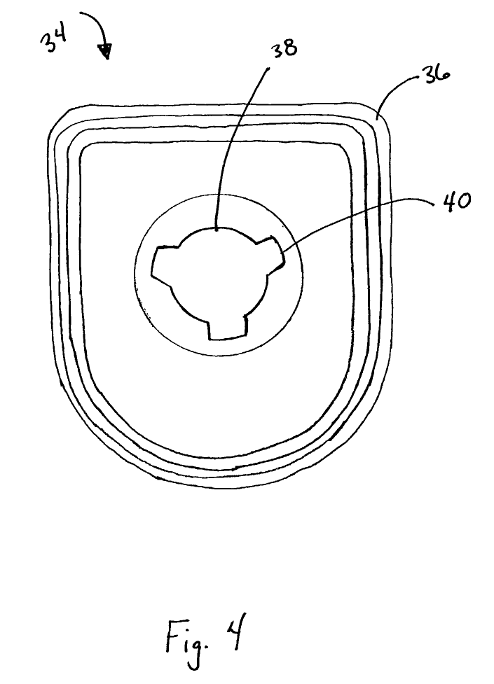

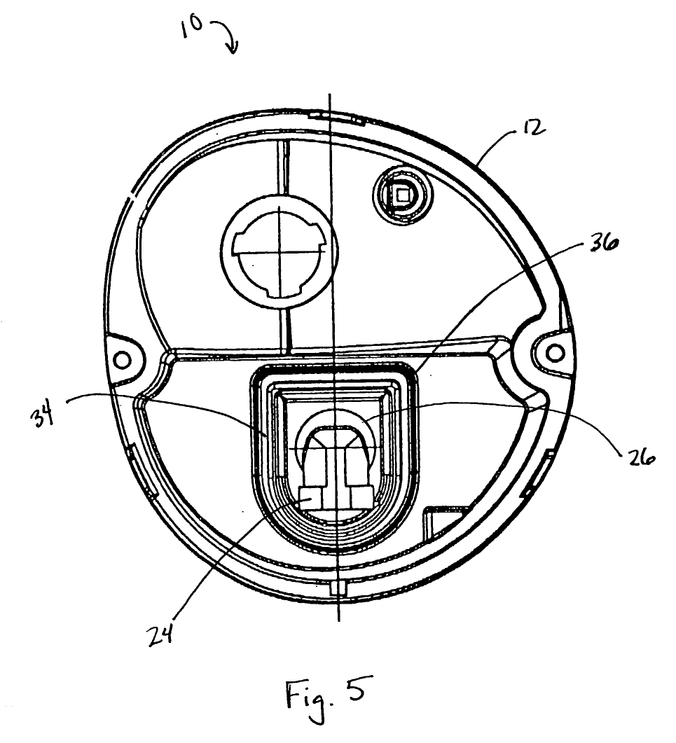

Referring to FIG. 4, which shows a rear view of an exemplary embodiment of sealing bulb boot 34, sealing bulb boot 34 is molded with boot opening 38 at its approximate center. Boot opening 38 is generally circular in cross-section but includes, in this exemplary embodiment, a plurality of boot notches 40. It will be appreciated by those of ordinary skill in the art that other exemplary embodiments of sealing bulb boot 34 may include only a single boot notch 40 or any plurality of boot notches 40. Generally, the number of boot notches 40 in sealing bulb boot 34 will directly correspond in size, number and shape to locking tabs 28 of light source 24. Additionally, if light source 24 contains some locking mechanism other than locking tabs 28, such as, for example, clips, then booting opening 38 and any necessary boot notches 40 would simply be modified appropriately to accept such other locking mechanism. FIG. 5 shows a rear view of automotive forward lighting assembly 10 with an exemplary embodiment of sealing bulb boot 34 in place.

During the assembly process, sealing bulb boot 34 is placed on housing 12 with outer lip 36 fitting around outer ridge 18. Sealing bulb boot 34 is sized such that outer lip 36 fits tightly around outer ridge 18 and presses into groove 20, thereby creating a tight seal around the outer perimeter of sealing bulb boot 34. Next, light source 24 is inserted through boot opening 38 and opening 30 in moveable reflector 22. Light source 24 is inserted in such a position that allows locking tabs 28 to pass through boot notches 40 and notches 32 in moveable reflector 22. As described above, light source 24 is then turned approximately one quarter turn so that locking tabs 28 lock into position with slots provided in moveable reflector 22. This fixedly locks light source 24 to moveable reflector 22 and firmly seats the inner portion of sealing bulb boot 34 between light source 24 and moveable reflector 22. Thus, the locking mechanism of light source 24 forms a tight seal around the inner portion of sealing bulb boot 34.

The present invention allows for sealing bulb boot 34 to be firmly seated between moveable reflector 22 and light source 24 with a simple turn of light source 24. The tight seal formed does not require any additional grooves to be molded into moveable reflector 22. Also, no additional gasket is required to create a seal around light source 24. In addition, positioning sealing bulb boot 34 between light source 24 and moveable reflector 22 forms a tight seal that does not require the use of additional means to retain sealing bulb boot 34.

By eliminating the need for additional means to retain sealing bulb boot 34 and the need for an additional gasket around light source 24, manufacturing costs can be lowered. Furthermore, the fact that sealing bulb boot 34 is firmly seated into place through the locking mechanism that fixedly secures light source 24 to moveable reflector 22 eliminates the need for additional grooves to be molded into moveable reflector 22 and minimizes the number of manufacturing steps required to firmly seat sealing bulb boot 34. Additionally, sealing bulb boot 34 does not need to be tightly fit around the “neck” of light source 24, thus further increasing the efficiency of the assembly process.

While the present invention has been described in considerable detail with reference to particular embodiments thereof, such is offered by way of non-limiting examples of the invention as many other versions are possible. For example, the automotive forward lighting assembly described herein was offered as but one example of such an assembly. Sealing bulb boot 34 could be utilized with many different vehicular lighting assemblies, such as for example, lighting assemblies for boats, planes, industrial equipment, as well as other automotive lighting applications. Additionally, it is anticipated that a variety of other modifications and changes will be apparent to those having ordinary skill in the art and that such modifications and changes are intended to be encompassed within the spirit and scope of the invention as defined by the appended claims.

1. A sealing bulb boot, comprising:
an outer perimeter, said outer perimeter comprising an outer lip; and
an opening located interior to said outer perimeter, said opening comprising at least one notch.

2. The sealing bulb boot of claim 1 wherein said opening is located at approximately the center of said sealing bulb boot.

3. The sealing bulb boot of claim 1 wherein said opening comprises three notches.

4. The sealing bulb boot of claim 1 wherein said sealing bulb boot is molded from a flexible material.

5. The sealing bulb boot of claim 4 wherein said flexible material is a thermoplastic rubber compound.

6. The sealing bulb boot of claim 4 wherein said sealing bulb boot is manufactured by injection molding.

7. The sealing bulb boot of claim 1 for use in a moveable reflector vehicle lighting assembly having a housing with a ridge and a light source with at least one tab projecting radially outwardly therefrom, wherein said outer lip is sealingly secured around the ridge.

8. The sealing bulb boot of claim 7 wherein the at least one tab is placed through said at least one notch of said opening.

9. The sealing bulb boot of claim 8 wherein the light source is rotated to sealingly connect the light source, the moveable reflector, and said sealing bulb boot.

10. A sealing bulb boot for use in a vehicle forward lighting assembly having a housing with a ridge, a moveable reflector, and a light source having a means for securing the light source to the moveable reflector, said sealing bulb boot comprising:
an outer perimeter comprising an outer lip, said outer lip fit sealingly around the ridge;
an opening located interior to said outer perimeter, said opening comprising at least one notch; and
wherein the light source is placed through said opening and the means for securing the light source to the movable reflector sealingly secures the light source and the moveable reflector to said sealing bulb boot.

11. The sealing bulb boot of claim 10 wherein said opening is located at approximately the center of said sealing bulb boot.

12. The sealing bulb boot of claim 10 wherein said opening comprises three notches.

13. The sealing bulb boot of claim 12 wherein said means for securing the light source to the moveable reflector comprises three tabs.

14. The sealing bulb boot of claim 13 wherein the three tabs are inserted through said three notches and the light source is rotated to sealingly connect the light source, the moveable reflector and said sealing bulb boot.

15. The sealing bulb boot of claim 10 wherein said sealing bulb boot is molded from a flexible material.

16. The sealing bulb boot of claim 15 wherein said flexible material is a black thermoplastic rubber compound.

17. The sealing bulb boot of claim 15 wherein said sealing bulb boot is manufactured by injection molding.

18. The sealing bulb boot of claim 10 wherein said means for securing the light source to the moveable reflector comprises at least one tab.

19. The sealing bulb boot of claim 18 wherein the light source is rotated to sealingly connect the light source, the moveable reflector, and said sealing bulb boot.
